(19) United States
(12) Patent Application Publication
(10) Pub. No.: US 2025/0083529 A1
(43) Pub. Date: Mar. 13, 2025

(54) BRAKING SYSTEM FOR A VEHICLE

(71) Applicant: YASA Limited, Kidlington (GB)

(72) Inventors: Timothy James Thursby WOOLMER, Kidlington (GB); Michael David PANTREY, Banbury (GB)

(21) Appl. No.: 18/884,961

(22) Filed: Sep. 13, 2024

(30) Foreign Application Priority Data
Sep. 13, 2023 (GB) 2313972.8

(51) Int. Cl. B60L 3/00; B60L 7/22

(52) U.S. Cl. CPC B60L 3/0076; B60L 7/22; B60L 2240/421; B60L 2240/423; B60L 2240/461; B60L 2250/26

(57) ABSTRACT

A braking system is described in which a synchronous electric machine mechanically coupleable to one or more wheels of a vehicle is used as a means of providing a controllable braking torque in the event that one or more of the components in the power train (for example the battery or inverter powering the synchronous electric machine) is in a fault condition. In such a fault condition, the electric machine generates uncontrolled regenerated currents when the rotor is rotating. A dump resistor is used to dissipate the uncontrolled regenerated currents and one or more switches in the current flow path are used to modulate the power through the dump resistor, thus creating a controllable braking system.

### CROSS REFERENCE TO RELATED APPLICATIONS

This application claims priority to and the benefit of United Kingdom Patent Application No. 2313972.8, filed in the United Kingdom on Sep. 13, 2023, the contents of which are herein incorporated by reference in its entirety for all purposes.

### FIELD OF THE INVENTION

The present invention relates to an electric or hybrid vehicle control device having a fail-safe dynamic brake function.

### BACKGROUND OF THE INVENTION

Regenerative braking has emerged as a key technology in the field of electric and hybrid vehicles, significantly enhancing energy efficiency and extending the range of these vehicles. By converting kinetic energy into electrical energy during deceleration and braking, regenerative braking systems help to minimise energy wastage and promote sustainable transportation solutions.

Much attention has been given to regenerative braking solutions for normal driving conditions as this is the most likely scenario and itself requiring inventive steps to maximise battery performance, reduce mass and aim for improved reliability/reduced maintenance. Under normal driving conditions there is usually assumed a multiphase traction motor or motors, driving wheels through an axel(s), or perhaps in-wheel motors in which each wheel is separately driven and coordinated through a central control system, a battery power source, an inverter controller to convert battery supplied DC voltage to the requisite multiphase voltage, often 3-phase, and vectored currents required of a multiphase motor. For IC/electric hybrids a similar set of electric systems is usually found blended with IC hardware and software.

Regenerative braking is usually controlled by an inverter which converts the vehicle's kinetic energy to a DC voltage and supplies power back to the battery. Such regeneration occurs e.g., when coasting down a hill and/or when applying the brake foot pedal to reduce speed, and in either case at least vehicle/wheel speed, brake and accelerator pedal positions provide necessary inputs to let the inverter know of torque and speed demands. In both example instances the inverter will seek to recover energy and if possible, charge the battery.

Under normal driving conditions, there will be instances where the battery is fully charged and cannot accept regen energy. In these instances, mechanical braking is an obvious choice to limit speed, and keep control of electric/hybrid vehicles and yet the electric motor is still generating voltage/energy which needs to be dissipated safely. Moving the motor into controlled active-short-circuit (ASC) is an option for absorbing power generated, which is not able to be fed to recharge a motive battery. ASC is accomplished in a controlled manner, by turning on upper bridge (or a lower bridge) switches of e.g., a 3-phase inverter so they are kept in a conducting state and thereby, short-circuit the stator windings of a 3-phase motor. US2014001987A1 teaches this approach in which an inverter uses vector control to meet a braking torque demand under normal operating conditions, when the battery power supply is full e.g., after overnight charging and a downhill slope is encountered early in a drive cycle which releases the potential for regen braking which cannot be deployed.

Conversely uncontrolled ASC is of interest as a ‘safe operating state’ where a controller/inverter is not operable, i.e., is in a fault condition. In this instance of uncontrolled ASC, there may be generated high transient stator currents if the stable ASC circulating current state differs significantly from the current state prior to switching. US2020186058A1 teaches a method to reduce the transient and also brings to the motor engineer's attention that uncontrolled ASC provides the highest braking torque at low speed and smaller braking torque at high speed. Switching to uncontrolled ASC at high motor speed i.e. >2000 rpm though helpful in protecting the inverter and power supply does little to reduce the speed of the motor in an emergency.

In instances where battery storage is full or not available and a drive motor is no longer able to internally dissipate regenerated energy there remains a need to dissipate converted kinetic energy, and a method of dumping regenerated energy into resistors is a solution.

US2014001987 exemplifies the use of modulated regenerative and controlled active short circuit techniques in regenerative braking. For normal brake torque demands and with no fault condition US'987 teaches three possible combinations of energy dissipation; primarily controlled ASC, with secondary alternatives regenerative braking and resistor energy dissipation, depending on battery state. Because reliance is given to pulse width modulation (PWM), vector control of ASC, US'987 teaches resistor power dissipation can be used as an ‘assist for short circuit braking’ and that as a consequence, relatively small amounts of energy are dissipated allowing for a simpler heat removal structure.

JPH10150702A takes a similar approach, but rather than increase the number of parts by introducing a power dissipation resistor, JPH'702 teaches a not operational motor is selected out of a clutch motor or an assist motor on the basis of connection states of a first clutch and a second clutch. The motor selected acts as a resistive power dissipation device with only d-axis current (field current) being fed to the three-phase coils of the motor, regenerated energy is consumed as a copper loss in the motor. Since a q-axis current (torque current) is not carried in the three-phase coils in the motor, torque is not developed and there is no influence on output of power other than the asked for braking.

The integration of controlled active short circuit techniques complements regenerative braking by efficiently dissipating excess energy that cannot be stored or recycled. This modulated approach, switching between regenerative, controlled short circuit and resistor dissipation modes is effective so long as heat generated in stator coils can be removed by stator cooling to ambient air, that field currents are not so high as to demagnetize permanent magnet rotor machines and crucially that the motor control unit and motive battery interface are working correctly.

However, in instances where there is a controller or battery storage fault or more commonly for controlled urgent braking from high speed, an auxiliary backup braking scheme is required. It is primarily for inverter/controller fault conditions and controlled urgent braking instances that mechanical brakes are retained in vehicles to provide the additional braking and kinetic-energy-to-heat dissipation offered, usually by brake discs and calipers.

Mechanical brakes are retained not because there is insufficient braking torque available in electric motors to reduce a vehicle's kinetic energy, but because the complexity of achieving safe and reliable electrodynamic braking is outweighed by the relative simplicity of mechanical brakes. In short, though mechanical brakes are not perfect there is acceptance of their deficiencies overwhelmed by their reliability and so they continue to be used as back-up for electrodynamic braking.

We have discussed the benefits of controlled ASC braking and some disadvantages of uncontrolled ASC braking. Its common knowledge among electric motor engineers that ASC is a safe state to retreat to if inverter/controller fault occurs, and the retreat to ASC is usually from the unsafe state of uncontrolled regeneration of power. Uncontrolled power regeneration is considered by motor engineers to be one of the most severe fault conditions and is where top and bottom (high & low) inverter switches are left, or driven open i.e., so called six-switch open (6SO) state for a 3-phase inverter and associated rectifying diodes freewheeling, allowing current generated in the motor/generator to pass unhindered towards the primary battery power source. Crucially the primary power source needs to be switched out of circuit to avoid damage, but other systems are at risk too.

Whereas for ASC, braking torque reduces as rotor speed increases, uncontrolled regeneration of power at high rotor speeds can cause immense problems of safety through uncontrolled high braking torques, and excessive and damaging voltages and currents. Controller faults that lead to uncontrolled regenerative braking is one of the most severe safety fault conditions and can cause loss of vehicle control and serious accidents, largely because the effects are more extreme at higher speeds. It may be appreciated that in comparison to uncontrolled regen, uncontrolled ASC is in fact a ‘safe state’.

We have therefore appreciated the need for an electric braking system that is suitable for a vehicle when one or more modules in the power train is in a fault condition and thus the electric machine is at risk of generating uncontrolled regenerative currents.

In reviewing prior-art approaches to address braking of electric and hybrid vehicles by blending electrodynamic with mechanical systems, we have appreciated there are weight saving, and, counter intuitively, safety advantages in removing at least part of mechanical auxiliary braking and replacing with a fully electrodynamic braking system. The electrodynamic braking system of the present invention is fault tolerant, does not rely on inverter motor control, does not rely on accessing a battery for motive power and significantly reduces mechanical complexity and weight whilst improving braking dynamics and safety. Other objects and features of the present invention will become apparent from the following description with reference to the accompanying drawings.

### SUMMARY OF THE INVENTION

The present invention is defined by the independent claims appended hereto. Further advantageous embodiments are also defined by the dependent claims, also appended hereto.

We describe an electric braking system for a vehicle, comprising: an electric machine mechanically coupleable to one or more wheels of a vehicle; an inverter for generating multi-phase AC output voltages from positive and negative DC input voltages for powering the electric machine, the positive and negative DC voltages being provided by respective positive and negative DC power rails, the inverter comprising: for each phase, a plurality of switches connected between the DC input voltages and a respective AC output; and a controller for controlling each of the switches using Pulse Width Modulation (PWM) over a plurality of PWM periods to generate the multi-phase AC output voltages for the electrical machine; a safe state braking system, comprising: a controller having an output for controlling one or more of the switches in the inverter; and a resistor connected between the positive and negative DC power rails, the resistor being connected in series with a controllable switch, wherein, during a fault condition, the controller of the safe state braking system is configured to: control one or more of the switch in series with the resistor and the switches of the inverter to use uncontrolled regenerated currents from the electric machine to apply a controlled braking torque to the rotor.

By using such an arrangement, uncontrolled regenerated currents generated by the electric machine when one or more components in the power train are in a fault condition may be used a controlled manner in order to provide a controllable braking torque to the rotor of the electric machine, and thus any wheel mechanically coupled to the electric machine.

In a first implementation, the controller of the safe state braking system may be configured to control one or more of the switches of the inverter in an open circuit mode in which all of the plurality of switches of the inverter are open, and the controller is configured to control the switch in series with the resistor to alternate between an open state and a closed state at a first frequency, and wherein the controlled braking torque is provided by the uncontrolled regenerated currents flowing through anti-parallel diodes connected to respective switches of the inverter, and through the resistor.

This implementation uses the switch in series with the resistor to modulate the uncontrolled regenerative currents being generated by the electric machine in order to provide the controlled braking torque at the rotor of the electric machine.

The controller of the safe state braking system may be configured to vary a period of time spent in each of the of the open state and closed state for the first frequency. The controller of the safe state braking system may be configured to vary the period of time spent in each of the of the open state and closed state between a first condition and a second condition, the first condition in which 100% of the period of time is in the closed state and 0% of the time is in the open state, and the second condition in which 0% of the period of time is in the closed state and 100% of the period of time is in the open state.

The proportion of time spent in each of the open state and closed state may be dependent on speed data indicative of a rotational speed of a rotor of the electric machine, and braking data may be indicative of a desired braking torque to apply to the electric machine to slow the rotational speed of the rotor of the machine. The rotational speed of the rotor of the electric machine may be proportional to a rotational speed of a wheel mechanically coupleable to the rotor of the electric machine. The desired braking torque may be proportional to a braking torque or power applied to a brake pedal by a user.

In a first technique of the first implementation, the controller of the safe state braking system may be configured to: measure a braking torque being applied to the electric machine; compare the measured braking torque applied to the electric machine to the desired braking torque of the braking data; and adjust the braking torque being applied to the electric machine to be within a threshold value of the desired braking torque of the braking data by controlling the proportion of time spent in each of the open state and closed state.

The controller may measure the braking torque being applied to the electric machine based on a voltage across the resistor, a current flowing through the resistor and an angular velocity of the rotor.

The controller of the safe state braking system may be configured to receive speed data indicative of a speed of one or more other wheels of the vehicle, and wherein the controller of the safe state braking system is configured to adjust the braking torque being applied to the electric machine in order to bring the speed of the respective wheel to be within a threshold value of the speed of one or more of the other wheels.

The controller may reduce the torque when the speed data indicates that the respective wheel is rotating at a speed that is greater or less than the threshold value of the speed of one or more of the other wheels. Alternatively, the controller of the safe state braking system may be configured to adjust the braking torque being applied to the electric machine in order to maintain a speed of the respective wheel that is less than a speed of one or more of the other wheels and within the threshold value.

In a second technique of the first implementation, the controller of the safe state braking system may determine the proportion of time spent in each of the open state and the closed state by comparing the speed data of the electrical machine and the braking data with a model defining values for the time spent in each of the open state and closed state for a plurality of values of respective speed data and braking data. The model may comprise a look up table.

In a second implementation, the controller of the safe state braking system may be configured to: close the switch in series with the resistor; and control one or more of the switches of the inverter to alternate between an open circuit mode in which all of the plurality of switches of the inverter are open, and a short circuit mode in which one or more of the plurality of switches in the inverter are closed at a first frequency, and wherein the controlled braking torque is provided by the uncontrolled regenerated currents flowing through anti-parallel diodes connected to respective switches of the inverter when in the open circuit mode, and through the resistor.

This second implementation uses the switches in the inverter switching between open circuit and short circuit modes to modulate the uncontrolled regenerative currents being generated by the electric machine in order to provide the controlled braking torque at the rotor of the electric machine.

In the second implementation, the controller of the safe state braking system may be configured to vary a period of time spent in each of the of the open circuit modes and short circuit modes for the first frequency. The controller of the safe state braking system may be configured to vary the period of time spent in each of the of the open circuit modes and short circuit modes between a first condition and a second condition, the first condition in which 100% of the period of time is in the short circuit mode and 0% of the time is in the open circuit mode, and the second condition in which 0% of the period of time is in the short circuit mode and 100% of the period of time is in the open circuit mode.

The proportion of time spent in each of the open circuit modes and short circuit modes may be dependent on speed data indicative of a rotational speed of a rotor of the electric machine, and braking data indicative of a desired braking torque to apply to the electric machine to slow the rotational speed of the rotor of the machine. The rotational speed of the rotor of the electric machine may be proportional to a rotational speed of a wheel mechanically coupleable to the rotor of the electric machine. The desired braking torque may be proportional to a braking torque or power applied to a brake pedal by a user.

In a first technique of the second implementation, the controller of the safe state braking system may be configured to: measure a braking torque being applied to the electric machine; compare the measured braking torque applied to the electric machine to the desired braking torque of the braking data; and control the proportion of time spent in each of the open circuit modes and short circuit modes in order to adjust the braking torque being applied to the electric machine to be within a threshold value of the desired braking torque of the braking data.

In the first technique of the second implementation, the controller may measure the braking torque being applied to the electric machine based on a voltage across the resistor, a current flowing through the resistor and an angular velocity of the rotor.

The controller of the safe state braking system may be configured to receive speed data indicative of a speed of one or more other wheels of the vehicle, and wherein the controller of the safe state braking system is configured to adjust the braking torque being applied to the electric machine in order to bring the speed of the respective wheel to be within a threshold value of the speed of one or more of the other wheels. The controller may reduce the torque when the speed data indicates that the respective wheel is rotating at a speed that is greater or less than the threshold value of the speed of one or more of the other wheels.

Alternatively, the controller of the safe state braking system may be configured to adjust the braking torque being applied to the electric machine in order to maintain a speed of the respective wheel that is less than a speed of one or more of the other wheels and within the threshold value.

In a second technique of the second implementation the controller of the safe state braking system may determine the proportion of time spent in each of the open circuit modes and the short circuit modes by comparing the speed data of the electrical machine and the braking data with a model defining values for the time spent in each of the open circuit modes and short circuit modes for a plurality of values of respective speed data and braking data. The model may comprise a look up table.

We also describe a vehicle comprising: a plurality of wheels; at least one electric machine, the at least one electric machine mechanically coupled to one or more of the plurality of wheels for driving the one or more of the plurality of wheels; an inverter for generating multi-phase AC output voltages from positive and negative DC input voltages for powering a respective electric machine, the positive and negative DC voltages being provided by respective positive and negative DC power rails, the inverter comprising: for each phase, a plurality of switches connected between the DC input voltages and a respective AC output; and a controller for controlling each of the switches using Pulse Width Modulation (PWM) over a plurality of PWM periods to generate the multi-phase AC output voltages for the electrical machine; a safe state braking system, comprising: a controller having an output for controlling one or more of the switches in the inverter; and a resistor connected between the positive and negative DC power rails, the resistor being connected in series with a controllable switch, wherein, during a fault condition, the controller of the safe state braking system is configured to: control one or more of the switch in series with the resistor and the switches of the inverter to use uncontrolled regenerated currents from the electric machine to apply a controlled braking torque to the rotor.

By using such an arrangement, uncontrolled regenerated currents generated by the electric machine when one or more components in the power train are in a fault condition may be used a controlled manner in order to provide a controllable braking torque to the rotor of the electric machine, and thus any wheel mechanically coupled to the electric machine.

In a first implementation, the controller of the safe state braking system may be configured to control one or more of the switches of the inverter in an open circuit mode in which all of the plurality of switches of the inverter are open, and the controller is configured to control the switch in series with the resistor to alternate between an open state and a closed state at a first frequency, and wherein the controlled braking torque is provided by the uncontrolled regenerated currents flowing through anti-parallel diodes connected to respective switches of the inverter, and through the resistor.

This implementation uses the switch in series with the resistor to modulate the uncontrolled regenerative currents being generated by the electric machine in order to provide the controlled braking torque at the rotor of the electric machine.

In the first implementation, the controller of the safe state braking system may be configured to vary a period of time spent in each of the open state and closed state for the first frequency. The controller of the safe state braking system may be configured to vary the period of time spent in each of the of the open state and closed state between a first condition and a second condition, the first condition in which 100% of the period of time is in the closed state and 0% of the time is in the open state, and the second condition in which 0% of the period of time is in the closed state and 100% of the period of time is in the open state.

The proportion of time spent in each of the open state and closed state may be dependent on speed data indicative of a rotational speed of a rotor of the electric machine, and braking data indicative of a desired braking torque to apply to the electric machine to slow the rotational speed of the rotor of the machine. The rotational speed of the rotor of the electric machine may be proportional to a rotational speed of a wheel mechanically coupleable to the rotor of the electric machine. The desired braking torque may be proportional to a braking torque applied to a brake pedal by a user.

In a first technique of the first implementation, the safe state controller of the safe state braking system may be configured to: measure a braking torque being applied to the electric machine; compare the measured braking torque applied to the electric machine to the desired braking torque of the braking data; and adjust the braking torque being applied to the electric machine to be within a threshold value of the desired braking torque of the braking data by controlling the proportion of time spent in each of the open state and closed state.

The safe state controller may measure the braking torque being applied to the electric machine based on a voltage across the resistor, a current flowing through the resistor and an angular velocity of the rotor.

The controller of the safe state braking system may be configured to receive speed data indicative of a speed of one or more of other of the plurality of wheels, and wherein the controller of the safe state braking system is configured to adjust the braking torque being applied to the electric machine in order to bring the speed of the respective wheel to be within a threshold value of the speed of one or more of the other plurality of wheels. The torque may be reduced when the speed data indicates that the respective wheel is rotating at a speed that is greater or less than the threshold value of the speed of one or more of the other plurality of wheels.

Alternatively, the controller of the safe state braking system may be configured to adjust the braking torque being applied to the electric machine in order to maintain a speed of the respective wheel that is less than a speed of one or more of the other plurality of wheel and within the threshold value.

In a second technique of the first implementation, the controller of the safe state braking system may determine the proportion of time spent in each of the open circuit modes and the short circuit modes by comparing the speed data of the electrical machine and the braking data with a model defining values for the time spent in each of the open circuit modes and short circuit modes for a plurality of values of respective speed data and braking data. The model may comprise a look up table.

In a second implementation, the controller of the safe state braking system may be configured to: close the switch in series with the resistor; and control one or more of the switches of the inverter to alternate between an open circuit mode in which all of the plurality of switches of the inverter are open, and a short circuit mode in which one or more of the plurality of switches in the inverter are closed at a first frequency, and wherein the controlled braking torque is provided by the uncontrolled regenerated currents flowing through anti-parallel diodes connected to respective switches of the inverter when in the open circuit mode, and through the resistor.

This second implementation uses the switches in the inverter switching between open circuit and short circuit modes to modulate the uncontrolled regenerative currents being generated by the electric machine in order to provide the controlled braking torque at the rotor of the electric machine.

The controller of the safe state braking system may be configured to vary a period of time spent in each of the of the open circuit modes and short circuit modes for the first frequency. The controller of the safe state braking system may be configured to vary the period of time spent in each of the of the open circuit modes and short circuit modes between a first condition and a second condition, the first condition in which 100% of the period of time is in the short circuit mode and 0% of the time is in the open circuit mode, and the second condition in which 0% of the period of time is in the short circuit mode and 100% of the period of time is in the open circuit mode.

The proportion of time spent in each of the open circuit modes and short circuit modes may be dependent on speed data indicative of a rotational speed of a rotor of the electrical machine, and braking data indicative of a desired braking force to apply to the electrical machine to slow the rotational speed of the rotor of the machine. The rotational speed of the rotor of the electric machine may be proportional to a rotational speed of one or more of the respective wheels of the vehicle mechanically coupled to the respective electric machine. The desired braking force may be proportional to a braking force, power or torque applied to a brake pedal by a user.

In a first technique of the first implementation, the controller of the safe state braking system may be configured to: measure a braking power being applied to the electric machine; compare the measured braking torque applied to the electric machine to the desired braking torque of the braking data; and control the proportion of time spent in each of the open circuit modes and short circuit modes in order to adjust the braking torque being applied to the electric machine to be within a threshold value of the desired braking torque of the braking data.

The controller measures the braking torque being applied to the electric machine based on a voltage across the resistor, a current flowing through the resistor and an angular velocity of the rotor.

The controller of the safe state braking system may be configured to receive speed data indicative of a speed of one or more of other of plurality of wheels, and wherein the controller of the safe state braking system is configured to adjust the braking torque being applied to the electric machine in order to bring the speed of the respective wheel to be within a threshold value of the speed of one or more of the other plurality of wheels. The controller may reduce the torque when the speed data indicates that the respective wheel is rotating at a speed that is greater or less than the threshold value of the speed of one or more of the other plurality of wheels.

Alternatively, the controller of the safe state braking system may be configured to adjust the braking torque being applied to the electric machine in order to maintain a speed of the respective wheel that is less than a speed of one or more of the other plurality of wheels and within the threshold value.

In a second technique of the second implementation, the controller of the safe state braking system may determine the proportion of time spent in each of the open circuit modes and the short circuit modes by comparing the speed data of the electrical machine and the braking data with a model defining values for the time spent in each of the open circuit modes and short circuit modes for a plurality of values of respective speed data and braking data. The model may comprise a look up table.

In any of the above, the first frequency may be at or around 10 kHz.

In any of the above, the safe state braking system may comprise a controllable supply switch in one or both of the DC supply rails supplying a DC voltage to the inverter, and wherein the controller of the safe state braking system is configured to open the supply switch during the fault condition to electrically disconnect the respective one or both DC supply rails from the input of the inverter.

A fault condition may comprise a condition where one or more components of the inverter and/or a DC source supplying the DC supply rails are in a fault condition. For example, when a fault condition lies with the inverter, this may be as a result of a problem with the Low Voltage supply that provides power to various components in the controller. Furthermore, fault conditions with the inverter may occur if there is a CANbus failure, where various components communicating via the vehicle's CANbus lose communication with each other resulting in the inverter controller being unable to control the switches correctly. There may be a fault with the micro-controllers within the inverter or inverter controller that would prevent the switches being switched correctly. There may be a failure in the position sensor data being sent to the controller (faulty sensor or broken wiring), or there may be a switch gate drive failure in the power electronics so that the power electronics within the controller can no longer switch the switches correctly. Other failure conditions are possible that would render the inverter and/or DC source supplying the DC supply rails inoperable or in a fault condition that would prevent normal operation of the devices.

In any of the above, the resistor may be configured to have a resistance of less than 5Ω, preferably less than 2.5Ω, more preferably in the region of 1Ω. The resistor may have a negative temperature coefficient.

The controller of the safe state braking system may be independent of the controller of the inverter.

In the vehicle, each wheel may be mechanically coupled to a respective electric machine.

In the vehicle, one or more of the wheels mechanically coupled to a respective electric machine may not be coupled to a mechanical braking system.

In any of the above, the electric machine may be an axial flux machine.

We also describe a braking system for a vehicle, comprising: a synchronous electric machine mechanically coupleable to one or more wheels of a vehicle; a rectifier electrically coupled to the synchronous electric machine for creating positive and negative DC output voltages; and a safe state braking system, comprising: a resistor electrically connected to the rectifier and a switch in the current flow path between the synchronous electric machine and the resistor; and a controller configured to control the switch, wherein, during a fault condition, the synchronous electric machine generates uncontrolled regenerated currents and the controller of the safe state braking system is configured to modulate the uncontrolled regenerated currents flowing through the resistor to apply a controlled braking torque to a rotor of the synchronous electric machine.

### LIST OF FIGURES

FIG. 1 shows a power system for an electric machine;

FIG. 2 shows a power system for an electric machine according the present invention;

FIG. 3 shows an example uncontrolled regenerative current flowing in the circuit when the switch SWR is closed and the inverter switches SW1-6 are in an open circuit condition;

FIG. 4 shows an example uncontrolled regenerative current flowing in the circuit when the switch SWR is closed and the inverter switches SW1-6 are in an active short circuit condition;

FIG. 5 shows a representations of the different operating points between the first condition (100% ASC; 0% 6SO) and the second condition (100% 6SO; 0% ASC); and

FIG. 6 shows an example of the shaft braking force (in kW) at different rpm of the rotor at different levels of ASC (and thus the complimentary 6SO proportions) for different resistor values (1Ω and 2.5Ω).

### DETAILED DESCRIPTION OF THE PREFERRED EMBODIMENTS

Automobiles are provided with a controlled motive source and means of braking such that a driver has control over the vehicle at low and high speeds. Typically, vehicles are provided with braking split front-to-rear in a ratio of 60:40 which accommodates increased force on front wheels as the vehicle slows.

For electric vehicles, the use of electrodynamic braking provides a means of assisting slowing of the vehicle through use of regenerative braking and passing power generated to the motive source battery.

The regenerative forces provided by modern electric machines, for example axial flux machines, has reached the stage where they may outperform the braking performance of many mechanical braking systems. This opens the possibility of providing vehicles where some or all of the wheels mechanically coupled to respective electric machines may be provided without any mechanical braking systems. For example, vehicles may be provided with one or more electric machines for each wheel. The rear wheels may be arranged to be powered by the respective electric machine and also have a braking torque provided by the respective electric machine. The front wheels may be powered by the electric machine, whilst also having a braking torque of the electric machine and also being provided with a mechanical braking system. In some instances, all wheels may be arranged only to have a braking torque applied by the respective electric machines, that is there are no mechanical braking systems coupled with any of the wheels in the vehicle.

However, this presents a problem in that a controllable braking torque will still need to be generated in order to slow the vehicle down even when one or more components in the power train are in a fault condition, for example a fault with the battery pack supplying power to the inverter coupled to the respective electric machines, or the inverter itself being in a fault condition.

The broad principle of the braking system and technique described herein is the use of a synchronous electric machine mechanically coupleable to one or more wheels of a vehicle as a means of providing a controllable braking torque in the event that one or more of the components in the power train (for example the battery or inverter powering the synchronous electric machine) is in a fault condition. In such a fault condition, the electric machine generates uncontrolled regenerated currents when the rotor is rotating. A dump resistor is used to dissipate the uncontrolled regenerated currents and one or more switches in the current flow path are used to modulate the power through the dump resistor, thus creating a controllable braking system. A means of rectifying the uncontrolled regenerated currents from the electric machine may be used.

In one implementation, the present invention provides a braking system suitable for a vehicle, which is able to provide a controllable braking torque to the electric machine even when part of the power train or other aspects of the vehicle systems are in a fault condition. The braking system comprises an electric machine that is mechanically coupleable to one or more wheels of a vehicle. An inverter generates multi-phase AC output voltages from a DC source for powering the electric machine (for example where the inverter controller uses Pulse Width Modulation to control a plurality of switches to generate the multi-phase AC output voltages). The braking system also comprises a safe state braking system comprising a resistor connected in series with a switch between the DC supply rails that is switchable. During a fault condition (for example with the battery or the inverter), a separate controller is configured to control one or more of the switch in series with the resistor and the switches of the inverter to use uncontrolled regenerated currents from the electric machine to apply a controlled braking torque to the rotor.

In one implementation, the braking torque is controlled by putting the switches of the inverter into an open state and alternating the switch in series with the resistor between an open and closed state at a first frequency. If the resistor has a sufficiently low enough resistance and high enough power rating, this provides a current flow path for the uncontrolled regenerated currents to flow and be dissipated in the form of heat when the switch is closed. Alternating between the closed (where braking torque is produced) and open (where little to no braking torque is produced) state enables the torque to be modulated and the torque value to be controlled.

In another alternative implementation, the braking torque is controlled by closing the switch in series with the resistor and alternately controlling one or more of the inverter switches to be in an open circuit mode and a closed circuit mode. If the resistor has a sufficiently low enough resistance and high enough power rating, this provides a current flow path for the uncontrolled regenerated currents to flow when the inverter switches are in the open circuit mode, and be dissipated in the form of heat. Alternating between the open circuit mode (where braking torque is produced) and closed circuit mode (where little to no braking torque is produced) enables the torque to be modulated and the torque value to be controlled.

The present invention is therefore directed to safely and rapidly reducing the speed of an electric vehicle without need for additional mechanical brakes by using switching of uncontrolled regenerative power through a load resistor to dissipate the energy and provide a controllable braking torque.

The present invention is particularly effective when applied to axial flux motors, because of high torque characteristics of this topology. However radial flux machines can take similar advantage, though with less effective braking at the motor, though this may be amplified by gearing.

Electric machines of the present invention may be operated as motors or generators. The former for motive power and the latter when applying regenerative braking to adjust the speed of the vehicle or locally adjust the torque to a wheel.

The present invention is particularly advantageous to vehicles in which an electric machine is mechanically coupled to one or more wheels of a vehicle. Examples include in-wheel and close to wheel motors on stub axles. Though motors connected to wheels via step up/step down gearbox or other transmission components may also take advantage of the present invention.

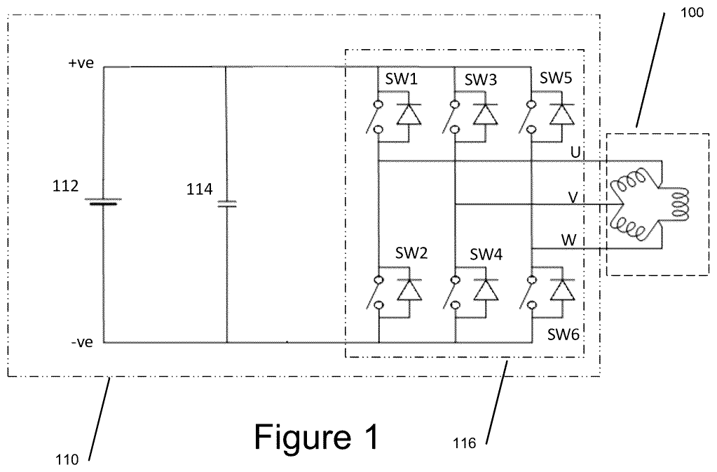

With reference to FIG. 1, which shows a prior art arrangement for driving an electric machine 100. The electric machines are multiphase synchronous AC machines supplied by an inverter 110 for generating multi-phase AC output voltages U, V, W, from a motive power source 112, for example a battery with positive and negative DC rails. An internal combustion engine driving a generator and converter (not shown) may also supply positive and negative DC power rails, or other power sources such as fuel cells, or one or more super/ultra capacitors.

The inverter 110 has a plurality of switches SW1-6 connected between the DC input voltages and a respective AC output for each phase, with a controller (not shown) controlling the switches using Pulse Width Modulation (PWM) over a plurality of PWM periods to generate the multi-phase AC output voltages U, V, W, for the electrical machine 100.

Whilst the figures show a three-phase output driving a three-phase electric machine (for example an axial flux machine) from a two-level three-phase inverter, the present invention is not limited to only two-level three-phase inverter arrangements and three-phase electric machines. Other multi-phase voltages and electric machine arrangements may be used. Similarly, other inverters having multi-level topologies may be used. However for the sake of simplicity, we shall refer only to three-phase voltages implemented with a three-phase two-level inverter arrangement.

Under normal operation, the inverter 110 generates the required output voltages and currents using PWM to control the switches in order to supply the electric machine 100 based on a torque demand provided to the inverter controller for example by an accelerator pedal in a vehicle. Under braking, for example when the user applies a force to the braking pedal of the vehicle, the inverter may be configured to utilise regeneration currents induced in the electric machine in order to apply a braking torque to the electric machine, and thus any wheels mechanically coupled to the electric machine. These regenerated currents may be passed to the battery pack.

As discussed above, the regenerative forces provided by modern electric machines, for example axial flux machines, has reached the stage where they may outperform the braking performance of many mechanical braking systems. This opens the possibility of providing vehicles where some or all of the wheels mechanically coupled to respective electric machines may be provided without any mechanical braking systems.

However, in such scenarios, where some or all wheels are not provided with a mechanical braking system, the system needs to be able to perform its braking function even when one or more modules in the power train (for example the battery pack or the respective inverter) are in a fault condition.

In a fault condition, for example if the inverter were to fail, and when the rotor of the electric machine is still rotating, a back EMF may still be generated in the electric machine and generated currents may still flow. If for example the switches of the inverter were to be left in the open state, and the back EMF generated by the electric machine was greater than the voltage from the DC source or across the DC capacitor 114, an uncontrolled generated current will flow through one or more of the anti-parallel diodes associated with the switches SW1-6 to the DC capacitor and power source. This causes a sudden and uncontrolled regenerative (braking) torque at the rotor and thus wheel mechanically coupled to the rotor until the voltages equalize. This uncontrolled regenerative torque could be dangerous in vehicles.

In prior art systems, one technique to reduce or alleviate the uncontrolled torque is to put all of the high switches (SW1, 3, 5) or all of the low switches (SW2, 4, 6) into a short circuit state, which causes the uncontrolled regenerated currents caused by the back EMF from the electric machine to feed back into the electric machine. In this technique, little to no useful braking torque is generated, resulting in a safer system albeit one in which no useful braking torque is possible.

The present invention utilises the properties of the uncontrolled regenerative currents in a power train fault condition in order to generate a controlled braking torque.

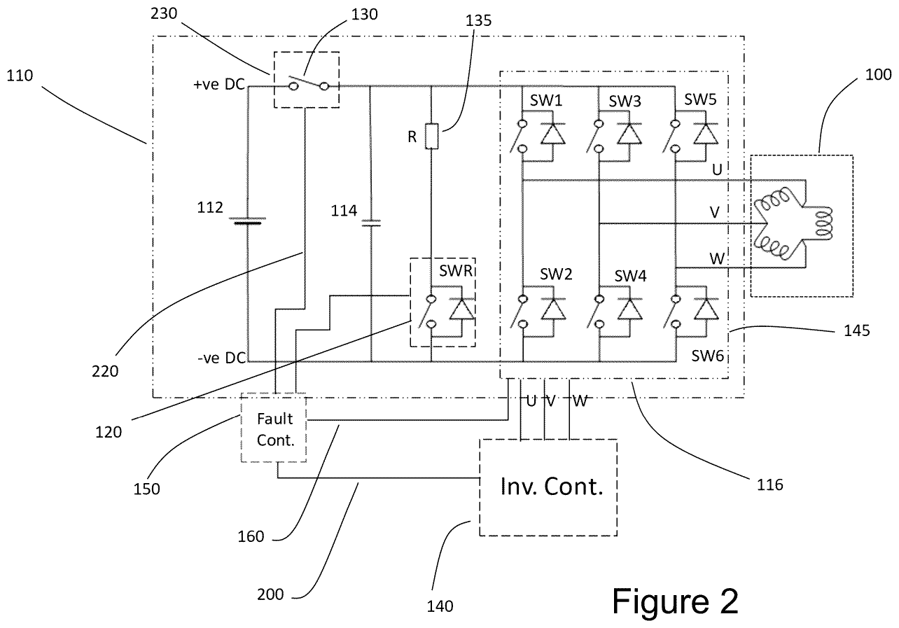

FIG. 2 shows an arrangement according to the present invention.

The arrangement of the present invention thus has additionally a means of enabling a safe, electrodynamic, controllable braking state in the event that one or more components are in a fault condition. These fault conditions may be due to one or more components in the power train being in a fault condition, for example one or both of the inverters, or even portions of the stator of the electric machine, for example the electric machine position sensor, phase imbalance or a partial short circuit.

The safe state braking system is provided by a separate independent controller 150 to the inverter controller 140 (which controls switches SW1-6 to generate the multi-phase output voltage as described above) having an output for controlling one or more of the switches SW1-6 in the inverter, and a resistor R connected between the positive and negative DC power rails. The resistor R is connected in series with a controllable switch SWR, which is connected to the safe state braking system controller 150.

The resistor R preferably has a low resistance, preferably less than 5Ω, more preferably less than 2.5Ω, and most preferably in the region of 0.5-1Ω. Preferably the resistor is capable of dissipating powers in the hundreds of kW. Preferably the resistor has a negative temperature coefficient, although it need not be. The purpose of the resistor is to dissipate energy from the uncontrolled regenerated currents from the electric machine. To give an example of the energy being considered, the energy required to reduce the speed of a vehicle moving at 320 kph to less than 100 kph may be in the region of 2MJ over a period of 3 s, or even less. The resistor is preferable sized to safely accommodate such large transfers of energy without impacting on the performance of surrounding materials or components. The resistor may be actively or passively cooled.

As discussed above, the broad principle of the braking system and technique described herein is the use of the synchronous electric machine which generates uncontrolled regenerated currents when the rotor is rotating and components in the power train are in a fault condition. A dump resistor R is used to dissipate the uncontrolled regenerated currents and one or more switches in the current flow path (SWR and/or any one or more of SW1-6) are used to modulate the power through the dump resistor R. As current flows through the dump resistor R, a braking torque on the rotor (and thus any wheel mechanically coupled to the rotor) is generated, thus creating a fault tolerant controllable braking system.

In a first implementation of the braking system, the controller 150 of the safe state braking system is configured to control one or more of the switches SW1-6 of the inverter in an open circuit mode in which all of the plurality of switches of the inverter are open. The controller 150 is configured to control the switch SWR in series with the resistor R to alternate between an open state and a closed state at a first frequency. This is preferably in the region of 10 kHz, although the technique is not so limited to this value.

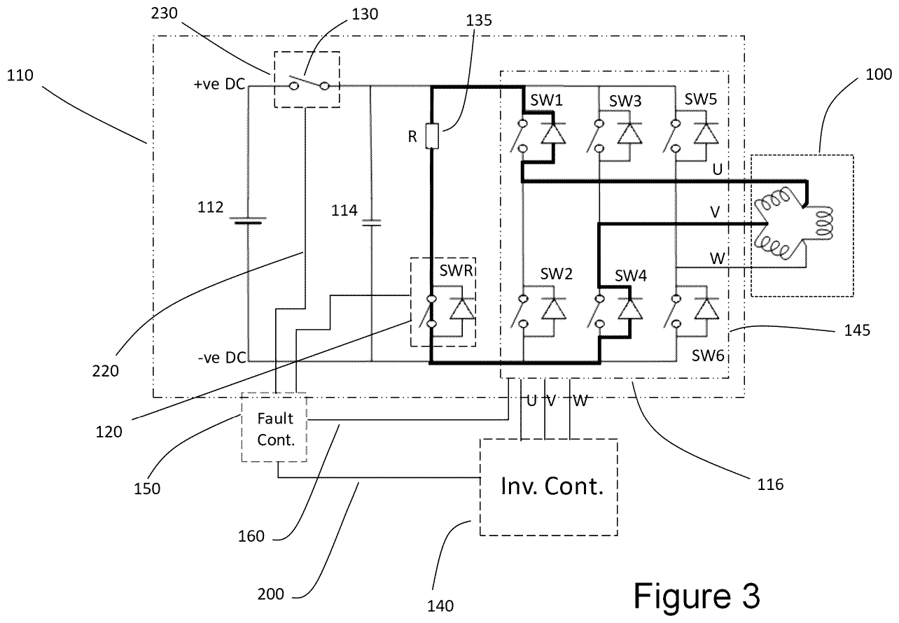

FIG. 3 shows an example uncontrolled regenerative current flowing in the circuit when the switch SWR is closed and the inverter switches SW1-6 are in an open circuit condition.

The controlled braking torque is provided by the uncontrolled regenerated currents flowing through anti-parallel diodes connected to respective switches SW1-6 of the inverter, and through the resistor. Since the resistor R has a very low resistance (preferably in the region of 0.5-10), the resistor dissipates the energy as heat. With this arrangement, braking powers in excess of 500 kW are possible.

If the switch were to remain permanently closed in this arrangement, there would be a continuous and large braking torque applied to the rotor. In order to control the amount of torque applied to the rotor, the present invention utilises a modulation technique whereby the controller 150 of the safe state braking system is configured to vary a period of time spent in each of the of the open state and closed state for the first frequency. The controller is able to vary the period or duty cycle of the open and closed states, akin to a pulse modulation scheme in order to vary the braking torque applied to the rotor.

At the two extremes, the controller is controlling the time spent in each of a first condition, in which 100% of the period of time is in the closed state and 0% of the time is in the open state (maximum braking torque is generated), and a second condition in which 0% of the period of time is in the closed state and 100% of the period of time is in the open state. In the open state, braking torque generation is much reduced since the uncontrolled regenerated current cannot flow through the low resistance resistor R.

In some implementations, the proportion of time spent in each of the open state and closed state of the switch SWR is dependent on speed data indicative of a rotational speed of a rotor of the electric machine, and braking data indicative of a desired braking torque to apply to the electric machine to slow the rotational speed of the rotor of the machine.

The rotational speed of the rotor of the electric machine may be proportional to a rotational speed of a wheel mechanically coupleable to the rotor of the electric machine, and this data may, for example, be provided by an Anti-lock Braking System (ABS) sensor (not shown in the figures).

The desired braking torque may be proportional to a braking torque applied to a brake pedal by a user. This may be in the form of a simple voltage that is proportional to a force applied to the brake pedal, or it may be in some other form know to the skilled reader.

There are two main techniques for controlling the switch SWR discussed below.

In the first technique, a simple control algorithm is enacted by the safe state braking system controller 150. In this technique, the controller 150 measures a braking torque being applied to the electric machine, and compares the measured braking torque applied to the electric machine to the desired braking torque supplied by the braking data. The controller 150 then adjusts the braking torque being applied to the electric machine to be within a threshold value of the desired braking torque of the braking data. The controller achieves this by controlling the proportion of time spent in each of the open state and closed state.

The threshold value enables a braking torque to be generated that either matches the desired braking torque, or to within a tolerance of the desired braking torque.

Such an implementation also enables other functions to be implemented, despite part of the power train being in a fault condition. For example, ABS functionality may be applied to the wheel mechanically coupled to the electric machine.

The controller 150 may be configured to receive speed data indicative of a speed of one or more other wheels of the vehicle. In the situation where the controller 150 detects that the speed of the wheel being controlled is rotating at a different speed to one or more of the other wheels of the vehicle, the controller 150 may adjust the braking torque being applied to the electric machine in order to bring the speed of the respective wheel to be within a threshold value of the speed of one or more of the other wheels.

That is, if the controller 150 detects that the speed of the wheel being controlled is spinning slower, indicating that the wheel is losing traction (for example locked, that is skidding, or slipping, indicating that a skid is likely), the controller 150 may reduce the braking torque being applied to the wheel and thus prevent the loss of traction. Once the speed data indicates that the wheels are turning at the same or similar rates, the controller 150 may then increase the braking torque again to reach the desired braking torque as demanded by the braking data.

Such an arrangement also enables a known and desired amount of wheel slip. Wheel slip occurs where the tyre associated with the wheel loses traction with the road surface. A complete loss of traction is a skid, and generally undesirable. However, in some scenarios some wheel slip (but not complete loss of traction) may be advantageous. As such, the technique described uses the controller 150 to adjust the braking torque being applied to the electric machine in order to maintain a speed of the respective wheel that is less than a speed of one or more of the other wheels and within the threshold value.

Various techniques may be used to determine or measure the braking torque generated at the rotor. However, the controller may determine the braking torque being applied to the electric machine based on a voltage across the resistor R, a current flowing through the resistor R and an angular velocity of the rotor.

In a second technique to control the switch SWR in series with the resistor R, the controller 150 may determine the proportion of time spent in each of the open state and the closed state by comparing the speed data of the electrical machine and the braking data with a model defining values for the time spent in each of the open state and closed state for a plurality of values of respective speed data and braking data.

In its simplest form, the model may comprise a Look Up Table (LUT) that defines a plurality of values of speed data and braking data and the required proportion of time for each of the closed and open states. The controller then needs to look up the respective entries for speed and braking data and implement the required proportion of time.

In a second, alternative, implementation of the safe state braking system, in the event that one or more modules in the power train are in a fault condition, the safe state braking system controller 150 is configured to close the switch SWR in series with the resistor R and control one or more of the switches of the inverter SW1-6 to alternate between an open circuit mode in which all of the plurality of switches of the inverter are open, and a short circuit mode in which one or more of the plurality of switches in the inverter are closed at the first frequency. As mentioned above, this first frequency is chosen to be at or around 10 kHz, although other frequencies may be used. The controlled braking torque is provided by the uncontrolled regenerated currents flowing through anti-parallel diodes connected to respective switches of the inverter when in the open circuit mode, and through the resistor.

In prior art systems, when an inverter is in a safe state, that is when the inverter is in a fault condition due to a fault with the inverter or battery pack, often the switches are put in an Active Short Circuit (ASC) configuration where either the high switches (SW1, 3 or 5) are short circuited, or the low switches (SW2, 4, 6) are short circuited. This arrangement provides a “safe state” in which 0 power is generated to prevent uncontrolled regeneration from the motor (uncontrolled regeneration could damage the battery pack or provide an uncontrolled amount of regenerative braking torque at the wheel). In this scenario where there is no mechanical braking system at the wheel, this is unacceptable as no braking force would be possible at the wheel in a fault condition.

The ASC technique also injects large currents into the electric machine (sometimes greater than 1,000 A in the Id axis), which can cause heating and possible demagnetisation in the electric machine.

The second implementation provides a solution in which the safe state braking system controller also controls the inverter switches in an open configuration. In the open configuration, current generated by the electric machine is permitted to flow in the circuit, but through the resistor R as a means of dissipating the energy in the form of heat. Thus a controlled regenerative force, and thus braking force may be provided to the wheel mechanically coupled to the electric machine. The regenerative torque at the rotor and thus the wheel mechanically coupled to the rotor of the electric machine is proportional to the current and voltage produced by the electric machine and the rotational speed of the electric machine. We will discuss this below.

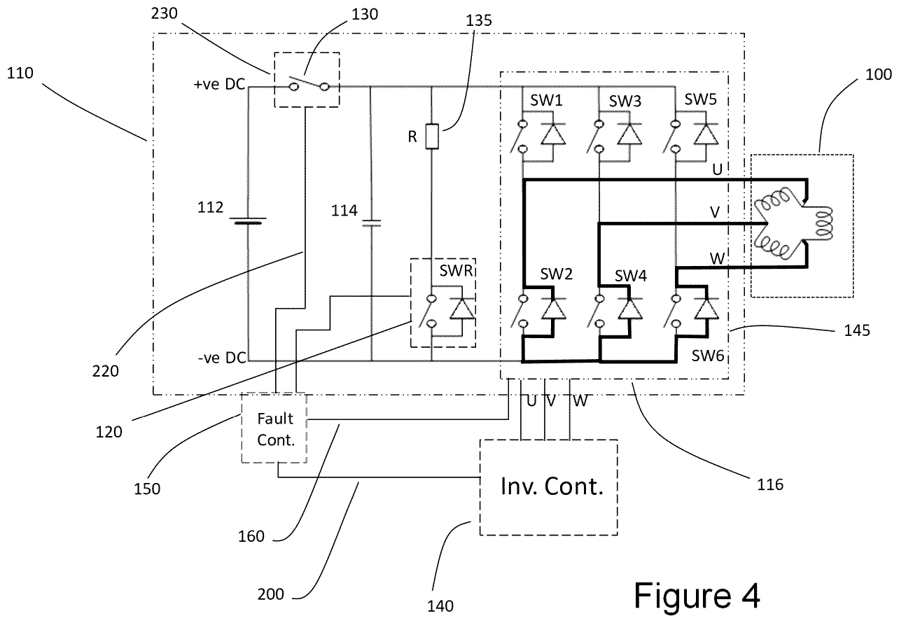

FIG. 4 shows an arrangement in which the safe state braking controller 150 has closed the switch SWR in series with the resistor R (due to a fault condition) and the lower switches (SW2, 4, 6) are in an ASC configuration. The controller 150 of the safe state braking system sends a control signal to one or more of the switches SW1-6 of the inverter to close either one, two or all of the top switches SW1, 3, 5 or one, two or all of the bottom switches SW2, 4, 6. In no circumstances is a shoot-through switch condition allowed in which e.g. switches SW1 and SW2 are close. As shown by thick black lines in FIG. 4 in the instance shown switches SW2, 4, 6 are closed in an active short circuit mode.

In the ASC configuration the torque is relatively small, particularly at medium to high speeds. As such, the safe state braking controller is also configured to use a switch open configuration in order to provide a controllable torque force to enable controlled braking.

As discussed above with reference to FIG. 3, this figure shows the configuration in which the safe state braking controller 150 has opened the switches SW1-6. This is sometimes referred to as SO configuration or 6SO in the case where all six switches of this particular implementation have been controlled in the open condition. In this state, the switches will conduct current through their respective bypass diodes along a circuit of the respective coupled phase windings of the electric machine when the back EMF from the uncontrolled regenerate voltages is great enough to overcome the voltages already present in the circuit.

As above, in the open condition, the safe state braking controller 150 has closed the switch SWR in series with the resistor R (due to a fault condition). Since generated current will flow through the respective bypass diodes, FIG. 3 shows a path for the current generated by one of the phase coils (between the U and V phase windings as show in this figure) of the electric machine via SW1 and SW4 and through the series resistor R. In this condition, the generated current has a flow path, the excess energy will be dissipated in the resistor R (in the form of heat) and torque will be generated that may be used to apply a braking force to the respective wheel mechanically coupled to this electric machine. Other phase coils will have different current paths through their respective diodes when the back EMF produced by the electric machine are great enough.

The torque generated in this open configuration is approximately as shown:

$$Torque ( 6 SO ) = \frac{Vres \times Ires}{2 π \times w}$$

Where:

Vres and Ires are the generated voltages and currents in the electric machine w is the angular velocity of the wheel

In the switch open configuration, using an implementation of the electric machine, and with a suitable resistor having a resistance of around 10, braking powers of in excess of 500 KW are achievable.

However, using only the switch open configuration and the switch SWR continuously closed, even in combination with the resistor, does not provide a controllable means of bringing a vehicle to a safe stop when one or more modules are in a fault condition.

If the switch SWR were to remain permanently closed and the inverter switches were to remain in the 6SO configuration, there would be a continuous and large braking torque applied to the rotor. In order to control the amount of torque applied to the rotor, the present invention utilises a modulation technique whereby the controller 150 of the safe state braking system is configured to vary a period of time spent in each of the of the open circuit modes and short circuit modes for the first frequency. The controller is able to vary the period or duty cycle of the open and short circuit modes, akin to a pulse modulation scheme in order to vary the braking torque applied to the rotor.

At the two extremes, the controller is controlling the time spent in each of a first condition, in which 100% of the period of time is in the short circuit mode and 0% of the time is in the open circuit mode (where minimum braking torque is generated), and a second condition in which 0% of the period of time is in the short circuit mode and 100% of the period of time is in the open circuit mode (where maximum braking torque is generated). In the short circuit mode, braking torque generation is much reduced since the uncontrolled regenerated current cannot flow through the low resistance resistor R (since the uncontrolled regenerated currents will take the path of least resistance, which is through the windings of the electric machine).

In some implementations, the proportion of time spent in each of the open circuit mode and short circuit mode of the inverter switches SW1-6 is dependent on speed data indicative of a rotational speed of a rotor of the electric machine, and braking data indicative of a desired braking torque to apply to the electric machine to slow the rotational speed of the rotor of the machine.

As above, the rotational speed of the rotor of the electric machine may be proportional to a rotational speed of a wheel mechanically coupleable to the rotor of the electric machine, and this data may, for example, be provided by an Anti-lock Braking System (ABS) sensor.

As above, the desired braking torque may be proportional to a braking torque applied to a brake pedal by a user. Again, this may be in the form of a simple voltage that is proportional to a force applied to the brake pedal, or it may be in some other form know to the skilled reader.

Similar to the first implementation described above, there are two main techniques for controlling the switches SW1-6 in order to achieve the desired braking torque.

In the first technique, a simple control algorithm is enacted by the safe state braking system controller 150. In this technique, the controller 150 measures a braking torque being applied to the electric machine, and compares the measured braking torque applied to the electric machine to the desired braking torque supplied by the braking data. The controller 150 then adjusts the braking torque being applied to the electric machine to be within a threshold value of the desired braking torque of the braking data. The controller achieves this by controlling the proportion of time spent in each of the open circuit modes and short circuit modes.

The threshold value enables a braking torque to be generated that either matches the desired braking torque, or to within a desired tolerance of the desired braking torque.

As above with the first implementation, such a technique also enables other functions to be implemented, despite part of the power train being in a fault condition. For example, ABS functionality may be applied to the wheel mechanically coupled to the electric machine.

The controller 150 may be configured to receive speed data indicative of a speed of one or more other wheels of the vehicle. In the situation where the controller 150 detects that the speed of the wheel being controlled is rotating at a different speed to one or more of the other wheels of the vehicle, the controller 150 may adjust the braking torque being applied to the electric machine in order to bring the speed of the respective wheel to be within a threshold value of the speed of one or more of the other wheels.

That is, if the controller 150 detects that the speed of the wheel being controlled is spinning slower, indicating that the wheel is losing traction (for example locked, that is skidding, or slipping, indicating that a skid is likely), the controller 150 may reduce the braking torque being applied to the wheel and thus prevent the loss of traction. Once the speed data indicates that the wheels are turning at the same or similar rates, the controller 150 may then increase the braking torque again to reach the desired braking torque as demanded by the braking data.

Such an arrangement also enables a known and desired amount of wheel slip. Wheel slip occurs where the tyre associated with the wheel loses traction with the road surface. A complete loss of traction is a skid, and generally undesirable. However, in some scenarios some wheel slip (but not complete loss of traction) may be advantageous. As such, the technique described uses the controller 150 to adjust the braking torque being applied to the electric machine in order to maintain a speed of the respective wheel that is less than a speed of one or more of the other wheels and within the threshold value.

Various techniques may be used to determine or measure the braking torque generated at the rotor. However, the controller may determine the braking torque being applied to the electric machine based on a voltage across the resistor R, a current flowing through the resistor R and an angular velocity of the rotor.

In a second technique to control the switches of the inverter SW1-6, the controller 150 may determine the proportion of time spent in each of the open circuit modes and the short circuit modes by comparing the speed data of the electrical machine and the braking data with a model defining values for the time spent in each of the open state and closed state for a plurality of values of respective speed data and braking data.

In its simplest form, the model may comprise a Look Up Table (LUT) that defines a plurality of values of speed data and braking data and the required proportion of time for each of the open circuit modes and short circuit modes. The controller then needs look up the respective entries for speed and braking data and implement the required proportion of time.

As such, the present invention implements a technique where the controller 150 of the safe state braking system is configured to control one or more of the switches of the inverter SW1-6 to alternate between the open circuit mode and the short circuit mode at a first frequency.

By alternating between the open circuit mode and short circuit mode, this enables the braking torque to be controlled, and applied to the wheel in a controlled manner, even when one or more of the modules in the power train are in a fault condition.

The controller of the safe state braking system varies a period of time spent in each of the open circuit modes and short circuit modes for the first frequency. As such, the regenerative torque may be represented as:

$$Torque brake = T \frac{Vres \times Ires}{2 π \times w} + ( 1 - T ) \times {T}_{ASC}$$

Where T is the mark space ratio of the open circuit and active short circuit modes. T_{ASC} is the active short circuit torque, which is typically close to zero in most cases (but not always, and increases as the angular velocity of the wheel is low).

In most cases, in particular when the vehicle is moving at speed, the equation for calculating torque can be simplified to:

$$Torque brake = T \frac{Vres \times Ires}{2 π \times w}$$

As such, the controller of the safe state braking system may vary the period of time spent in each of the of the open circuit modes and short circuit modes between a first condition and a second condition. In the first condition 100% of the period of time is in the short circuit mode (that is close to 0 torque force is generated) and 0% of the time is in the open circuit mode. In the second condition 0% of the period of time is in the short circuit mode and 100% of the period of time is in the open circuit mode (that is maximum regenerative torque is generated). The controller may vary the periods in each of the open and closed circuit modes at different points between these two conditions at the extremities of the operating conditions.

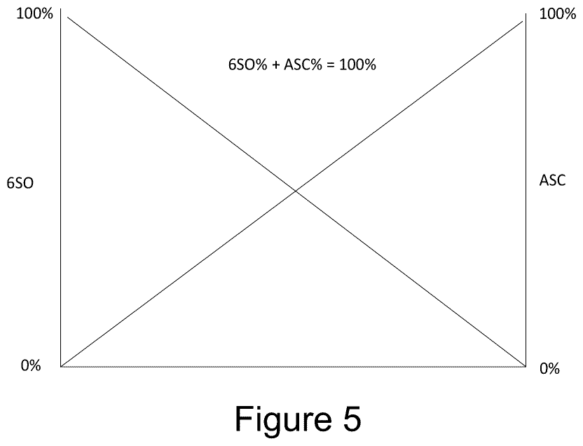

FIG. 5 shows a representations of the different operating points between the first condition (100% ASC; 0% 6SO) and the second condition (100% 6SO; 0% ASC).

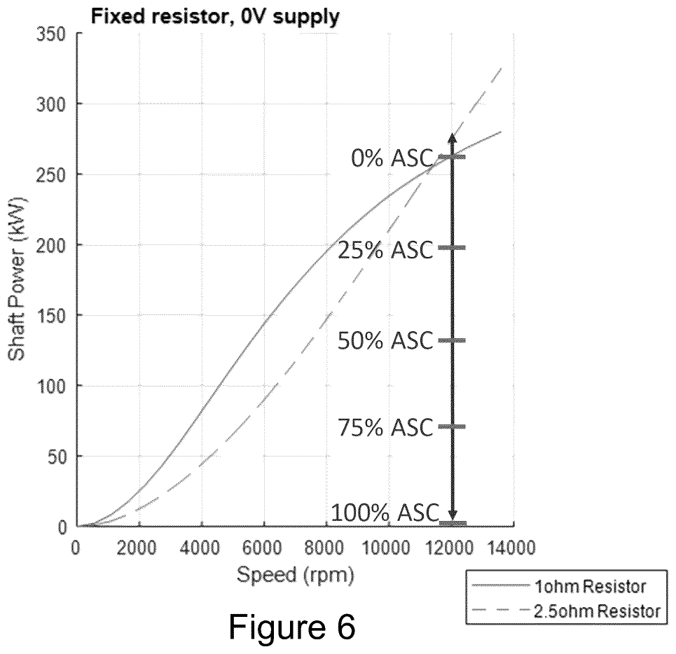

FIG. 6 shows the shaft braking force (in kW) at different rpm of the rotor at different levels of ASC (and thus the complimentary 6SO proportions) for different resistor values (1Ω and 2.5Ω). As can be seen, in the first condition (100% ASC; 0% 6SO), the torque power is at or near 0, and in the second condition (100% 6SO; 0% ASC), the torque power is at a maximum. Varying the proportion of ASC and 6SO between these two conditions thus enables a variable, and controllable, amount of braking force to be applied to the wheel using the uncontrolled regenerative currents from the electric machine.

With reference to FIGS. 2, 3 and 4, the safe state braking system may also comprise a controllable supply switch 130 in one or both of the DC supply rails supplying a DC voltage to the inverter. Only shown on one supply rail in these figures for the sake of simplicity. The controller 150 may be configured to open the supply switch during the fault condition to electrically disconnect the respective one or both DC supply rails from the input of the inverter. This is advantageous in protecting the battery pack from undesirable currents flowing back into the pack during the fault state, or protecting the inverter and other components in the power train from the battery pack if it is the battery pack in the fault condition.

In the scenario where a vehicle comprises a plurality of electric machines (for example one per wheel), each electric machine will be powered by a respective inverter, and each of those inverters is provided with a safe state braking system as described above. As such, the system may be provided with respective supply switches 130, each being capable of isolating respective inverters and electric machines from the battery pack 112. Since each of the safe state braking systems may operate independently, only the faulty power train may be isolated from the battery pack (assuming that the battery pack is not in the fault condition).

In any of the above implementations, the safe state braking system controller 150 is independent of the respective inverter controllers 140. This enables a fault tolerant safe state braking system to be implemented should the inverter controller be the module in the power train that is in the fault condition. The safe state braking system controller 150 may be provided by an FGPA or an ASIC; preferably a component with minimum or no software that can meet ASIL D functional safety requirements.

As described above, the electric machine described above may be any synchronous electric machine such as a radial flux machine or an axial flux machine. The preferred implementations use an axial flux machine due to their advantageous performance for a given weight and volume, but the above implementations and techniques are not limited to axial flux machines.

No doubt many other effective alternatives will occur to the skilled person. It will be understood that the invention is not limited to the described embodiments and encompasses modifications apparent to those skilled in the art lying within the scope of the claims appended hereto.

1. An electric braking system for a vehicle, comprising:
an electric machine mechanically coupleable to one or more wheels of a vehicle and including a rotor;
an inverter for generating multi-phase AC output voltages from positive and negative DC input voltages for powering the electric machine, the positive and negative DC voltages being provided by respective positive and negative DC power rails, the inverter comprising:
for each phase, a plurality of switches connected between the DC input voltages and a respective AC output; and
a controller for controlling each of the switches using Pulse Width Modulation (PWM) over a plurality of PWM periods to generate the multi-phase AC output voltages for the electric machine;
a safe state braking system, comprising:
a controller having an output for controlling one or more of the switches in the inverter; and
a resistor connected between the positive and negative DC power rails, the resistor being connected in series with a controllable switch,
wherein, during a fault condition, the controller of the safe state braking system is configured to: control one or more of the switch in series with the resistor, and the switches of the inverter to use uncontrolled regenerated currents from the electric machine to apply a controlled braking torque to a rotor of the electric machine.

2. The electric braking system of claim 1, wherein the controller of the safe state braking system is configured to control one or more of the switches of the inverter in an open circuit mode in which all of the plurality of switches of the inverter are open, and the controller is configured to control the switch in series with the resistor to alternate between an open state and a closed state at a first frequency, and
wherein the controlled braking torque is provided by the uncontrolled regenerated currents flowing through anti-parallel diodes connected to respective switches of the inverter, and through the resistor.

3. The electric braking system of claim 2, wherein the controller of the safe state braking system is configured to vary a period of time spent in each of the open state and the closed state for the first frequency.

4. The electric braking system of claim 3, wherein the controller of the safe state braking system is configured to vary the period of time spent in each of the open state and the closed state between a first condition and a second condition, the first condition in which 100% of the period of time is in the closed state and 0% of the time is in the open state, and the second condition in which 0% of the period of time is in the closed state and 100% of the period of time is in the open state.

5. The electric braking system of claim 3, wherein a proportion of time spent in each of the open state and the closed state is dependent on speed data indicative of a rotational speed of the rotor of the electric machine, and braking data indicative of a desired braking torque to apply to the electric machine to slow the rotational speed of the rotor of the electric machine.

6. The electric braking system of claim 5, wherein the rotational speed of the rotor of the electric machine is proportional to a rotational speed of one of the one or more wheels that are mechanically coupleable to the rotor of the electric machine.

7. The electric braking system of claim 5, wherein the desired braking torque is proportional to a braking torque applied to a brake pedal by a user.

8. The electric braking system of claim 5, wherein the controller of the safe state braking system is configured to:
measure a braking torque being applied to the electric machine;
compare the measured braking torque applied to the electric machine to the desired braking torque of the braking data; and
adjust the braking torque being applied to the electric machine to be within a threshold value of the desired braking torque of the braking data by controlling the proportion of time spent in each of the open state and the closed state.

9. The electric braking system of claim 8, wherein the controller measures the braking torque being applied to the electric machine based on a voltage across the resistor, a current flowing through the resistor and an angular velocity of the rotor.

10. The electric braking system of claim 8, wherein the controller of the safe state braking system is configured to receive speed data indicative of a speed of one or more other wheels of the vehicle, and wherein the controller of the safe state braking system is configured to adjust the braking torque being applied to the electric machine in order to bring the speed of the respective wheel to be within a threshold value of the speed of one or more of the other wheels.

11. The electric braking system of claim 10, wherein the torque is reduced when the speed data indicates that the respective wheel is rotating at a speed that is greater or less than the threshold value of the speed of one or more of the other wheels.

12. The electric braking system of claim 10, wherein the controller of the safe state braking system is configured to adjust the braking torque being applied to the electric machine in order to maintain a speed of the respective wheel that is less than a speed of one or more of the other wheels and within the threshold value.

13. The electric braking system of claim 5, wherein the controller of the safe state braking system determines the proportion of time spent in each of the open state and the closed state by comparing the speed data of the electric machine and the braking data with a model defining values for the time spent in each of the open state and the closed state for a plurality of values of respective speed data and braking data.

14. The electric braking system of claim 1, wherein the controller of the safe state braking system is configured to:
close the switch in series with the resistor; and
control one or more of the switches of the inverter to alternate between an open circuit mode in which all of the plurality of switches of the inverter are open, and a short circuit mode in which one or more of the plurality of switches in the inverter are closed at a first frequency, and
wherein the controlled braking torque is provided by the uncontrolled regenerated currents flowing through anti-parallel diodes connected to respective switches of the inverter when in the open circuit mode, and through the resistor.

15. The electric braking system of claim 14, wherein the controller of the safe state braking system is configured to vary a period of time spent in each of the of the open circuit modes and short circuit modes for the first frequency.

16. The electric braking system of claim 15, wherein the controller of the safe state braking system is configured to vary the period of time spent in each of the of the open circuit modes and the short circuit modes between a first condition and a second condition, the first condition in which 100% of the period of time is in the short circuit mode and 0% of the time is in the open circuit mode, and the second condition in which 0% of the period of time is in the short circuit mode and 100% of the period of time is in the open circuit mode.

17. The electric braking system of claim 15, wherein a proportion of time spent in each of the open circuit modes and the short circuit modes is dependent on speed data indicative of a rotational speed of the rotor of the electric machine, and braking data indicative of a desired braking torque to apply to the electric machine to slow the rotational speed of the rotor of the electric machine.

18. The electric braking system of claim 17, wherein the rotational speed of the rotor of the electric machine is proportional to a rotational speed of one of the one or more wheels that are mechanically coupleable to the rotor of the electric machine.

19. The electric braking system of claim 17, wherein the desired braking torque is proportional to a braking torque applied to a brake pedal by a user.

20. The electric braking system of claim 17, wherein the controller of the safe state braking system is configured to:
measure a braking torque being applied to the electric machine;
compare the measured braking torque applied to the electric machine to the desired braking torque of the braking data; and
control a proportion of time spent in each of the open circuit modes and the short circuit modes in order to adjust the braking torque being applied to the electric machine to be within a threshold value of the desired braking torque of the braking data.

21. The electric braking system of claim 20, wherein the controller measures the braking torque being applied to the electric machine based on a voltage across the resistor, a current flowing through the resistor and an angular velocity of the rotor.

22. The electric braking system of claim 20, wherein the controller of the safe state braking system is configured to receive speed data indicative of a speed of one or more other wheels of the vehicle, and wherein the controller of the safe state braking system is configured to adjust the braking torque being applied to the electric machine in order to bring the speed of the respective wheel to be within a threshold value of the speed of one or more of the other wheels.

23. The electric braking system of claim 22, wherein the torque is reduced when the speed data indicates that the respective wheel is rotating at a speed that is greater or less than the threshold value of the speed of one or more of the other wheels.

24. The electric braking system of claim 22, wherein the controller of the safe state braking system is configured to adjust the braking torque being applied to the electric machine in order to maintain a speed of the respective wheel that is less than a speed of one or more of the other wheels and within the threshold value.

25. The electric braking system of claim 17, wherein the controller of the safe state braking system determines the proportion of time spent in each of the open circuit modes and the short circuit modes by comparing the speed data of the electric machine and the braking data with a model defining values for the time spent in each of the open circuit modes and the short circuit modes for a plurality of values of respective speed data and braking data.

26. A vehicle comprising:
a plurality of wheels; and
an electronic braking system according to claim 1, wherein
the vehicle further comprises:
at least one electric machine mechanically coupled to one or more of the plurality of wheels for driving the one or more of the plurality of wheels

27. The vehicle of claim 26, wherein one or more of the wheels mechanically coupled to a respective electric machine is not coupled to a mechanical braking system.
